(19) United States
(12) Patent Application Publication
(10) Pub. No.: US 2014/0167369 A1
(43) Pub. Date: Jun. 19, 2014

(54) CHUCK

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: LING-HONG ZENG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/864,283

(22) Filed: Apr. 17, 2013

(30) Foreign Application Priority Data
Dec. 19, 2012 (CN) 201210553301.8

(51) Int. Cl. B23B 31/10; B23Q 3/12

(52) U.S. Cl. CPC B23B 31/101; B23Q 3/12
USPC 279/126; 279/140

(57) ABSTRACT

A chuck includes a chassis, a support member, a number of jaws, and a number of bolts. The chassis includes a mounting portion secured to a target machine. The support member is rotatably connected to the chassis and includes a support plate defining a number of radially extending first slots. The jaws each include an engaging surface. The bolts each include a head with a diameter greater than a width of the first slot and a shank connected to the head. The shank extends through one of the first slots of the support plate and is screwed into one of the jaws for securing the one of the jaws to the support plate. The engaging surfaces of the jaws is configured to contact a top surface of a workpiece placed on the support member for holding the workpiece in position.

### BACKGROUND

1. Technical Field

The present disclosure relates to chucks for holding a workpiece in position, and particularly to a chuck having dependent jaws.

2. Description of Related Art

A wide variety of chucks have been developed to hold a workpiece in the art. Most of the chucks have several jaws arranged in a radially symmetrical pattern to hold the workpiece therebetween, and the jaws will be tightened or loosened with the help of a chuck key. Although the chucks can satisfy basic requirements, a new type of chuck is still desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a chuck according to an exemplary embodiment.

FIG. 2 is an exploded, isometric view of the chuck of FIG. 1.

FIG. 3 is similar to FIG. 1, but viewed from a reverse perspective.

FIG. 4 is an isometric view of the chuck of FIG. 1 being used in assembling a workpiece.

### DETAILED DESCRIPTION

Embodiments of the present disclosure are now described in detail, with reference to the accompanying drawings.

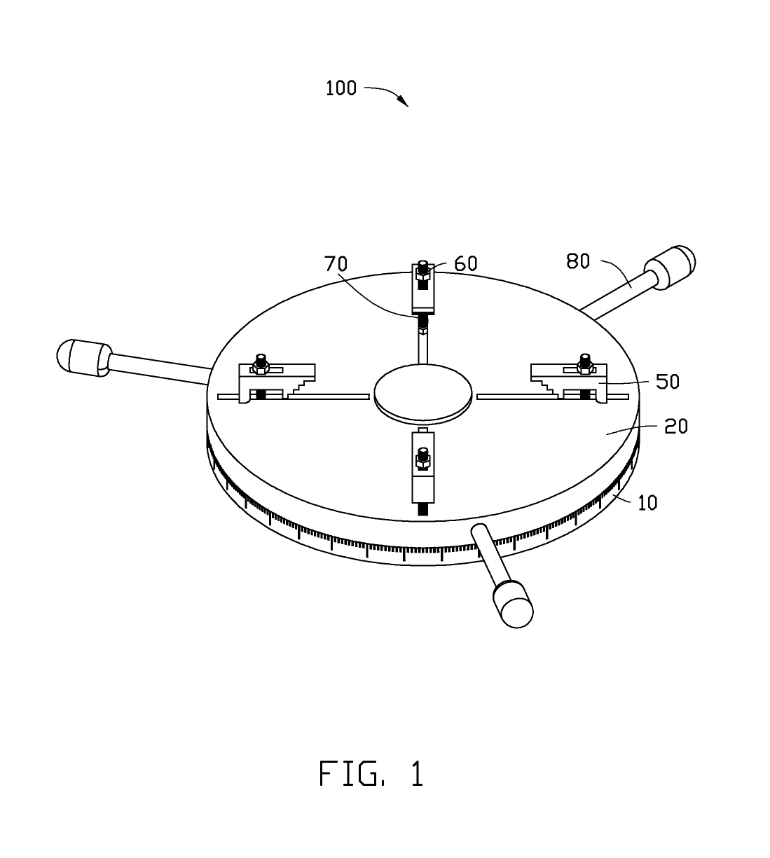

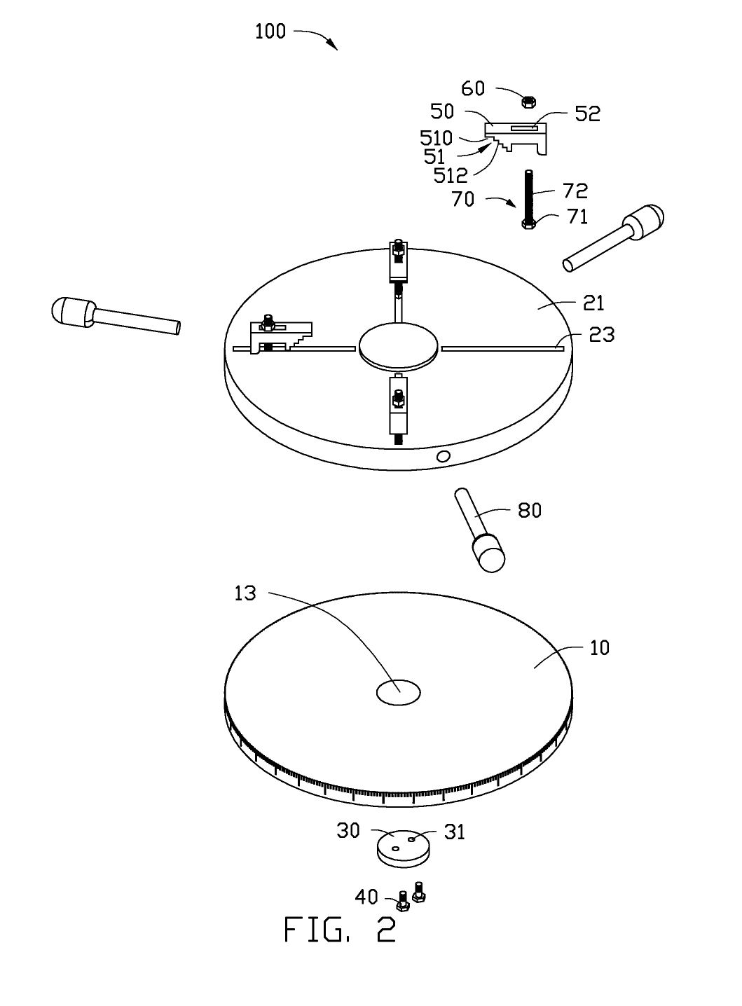

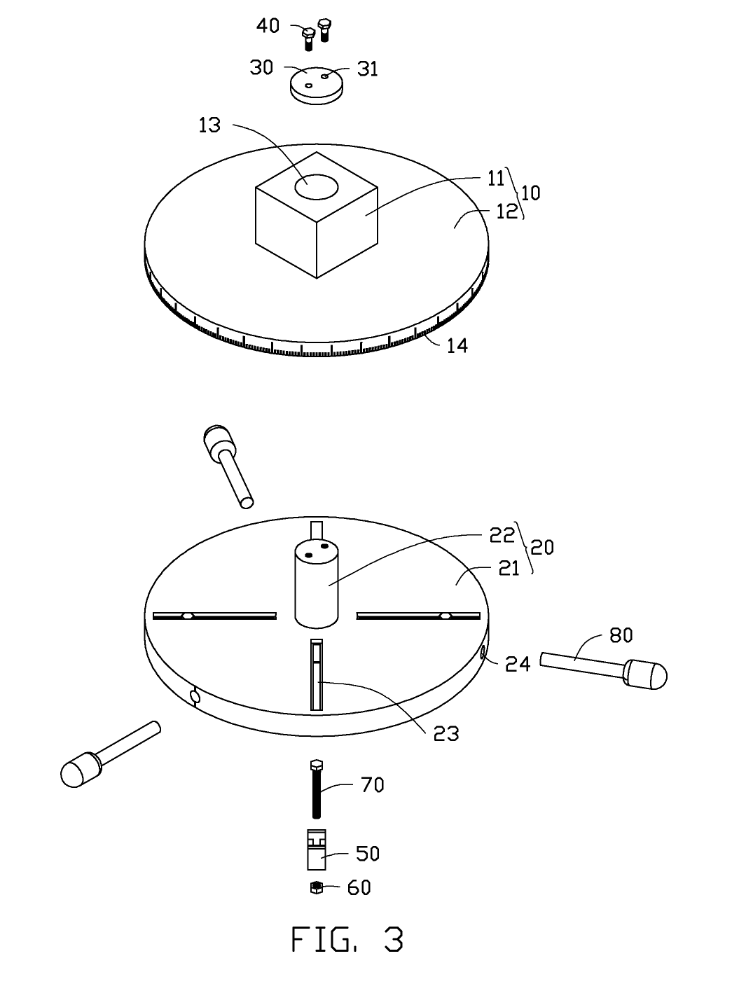

Referring to FIGS. 1-3, a chuck 100 according to an exemplary embodiment is illustrated. The chuck 100 includes a chassis 10, a support member 20 rotatably connected to the chassis 10, a fixing plate 30, two fasteners 40, four jaws 50, four nuts 60, four bolts 70, and three handles 80.

The chassis 10 includes a rectangular mounting portion 11 and a round base plate 12 connected to the mounting portion 11. The mounting portion 11 is secured to a target machine (not shown), e.g. a lathe. The chassis 10 defines a through hole 13 extending through both the mounting portion 11 and the base plate 12. A number of graduation lines 14 are formed on a circumferential surface of the base plate 12 for indicating a rotation angle of the support member 20.

The support member 20 includes a support plate 21 and a shaft 22 protruding from one side of the support plate 21. The support plate 21 defines four radially extending first slots 23 extending through the support plate 21 of the chassis 10 and three sliding holes 24 in a lateral surface thereof. In the embodiment, the support plate 21 is round and a diameter thereof is substantially equal to the diameter of the base plate 12.

The fasteners 40 extend through the stopper plate 30 and are screwed into the distal end of the shaft 22, thereby rotatably connecting the support member 20 to the chassis 10.

Each jaw 50 includes an engaging surface 51 at one end thereof and defines a second slot 52 in parallel to a corresponding one of the first slots 23.

Each bolt 70 includes a head 71 and a shank 72 connected to the head 71. A diameter of the head 71 is greater than a width of the first slot 23, and a diameter of the shank 72 is less than the width of the first slot 23 and the second slot 52. The shank 72 extends through both the first slot 23 and the second slot 52, and is screwed into the nut 60, thereby securing the jaw 50 to the support plate 21.

The handles 80 are slidably received in the sliding holes 24 of the support plate 21. When the handles 80 are not occupied, the handles 80 can be inserted further into or detached from the sliding holes 24 of the support plate 21.

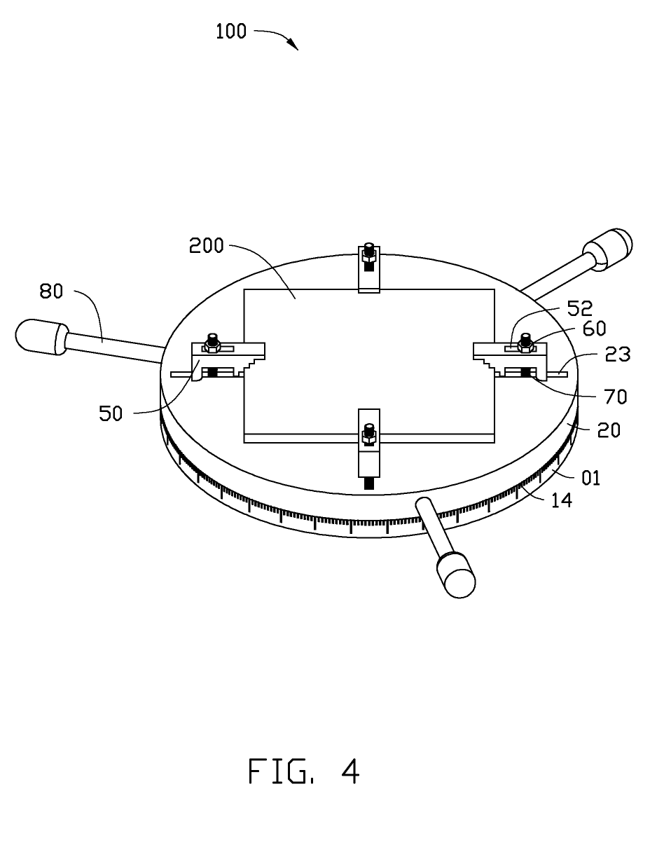

Referring also to FIG. 4, the workpiece 200 is positioned on the support plate 21 and held in position by the engaging surfaces 51 of the four jaws 50. When needed, the nuts 60 can be rotated to allow the jaws 50 to slide along the first slots 51 and the second slots 52 for narrowing or widening a space therebetween, and the user can thus detach or attach the workpieces 200 of different sizes. In the embodiment, the engaging surfaces 51 of the jaws 50 are stepped and each include a number of horizontal surfaces 510 and a number of vertical surfaces 512 alternately connected to each other for allowing the chuck 100 to be adapted to the workpieces 200 of different heights.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A chuck comprising:
a chassis comprising a mounting portion for being secured to a target machine;
a support member rotatably connected to the chassis and comprising a support plate defining a plurality of radially extending first slots;
a plurality of jaws each comprising an engaging surface; and
a plurality of bolts each comprising a head with a diameter greater than a width of the first slot and a shank connected to the head, the shank extending through one of the first slots of the support plate and being screwed into one of the jaws for securing the one of the jaws to the support plate, the engaging surfaces of the plurality of jaws configured for contacting a top surface of a workpiece placed on the support member, thereby holding the workpiece in position.

2. The chuck as described in claim 1, further comprising a stopper plate and at least one fasteners, wherein the chassis defines a through hole, the support member comprises a shaft connected to the support plate and extending through the through hole, and the at least one fasteners extends through the stopper plate and are secured to a distal end of the shaft, thereby rotatably connecting the support member to the chassis.

3. The chuck as described in claim 2, wherein the chassis comprises a round base plate connected to the mounting portion, and a plurality of graduation lines are formed on a circumferential surface of the base plate for indicating a rotation angle of the support member.

4. The chuck as described in claim 3, wherein the support plate is a round plate and a diameter of the support plate is substantially equal to that of the base plate.

5. The chuck as described in claim 3, further comprising at least one handle, wherein the support plate defines at least one sliding hole, and the at least one handle is slidably received in the at least one sliding hole.

6. The chuck as described in claim 1, further comprising a plurality of nuts, wherein the plurality of jaws each define a second slot in parallel to one of the first slots, and the shanks of the bolts extend through the second slot and are screwed into one of the nuts.

7. The chuck as described in claim 1, wherein the engaging surface of each of the jaws is a stepped surface.
